(19) United States
(12) Patent Application Publication
(10) Pub. No.: US 2005/0198310 A1
(43) Pub. Date: Sep. 8, 2005

(54) Method of communicating with server having flexible address

(75) Inventors: Pyung-soo Kim, Seoul (KR); Sun-woo Kim, Suwon-si (KR); Young-keun Kim, Metropolitan-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/073,607

(22) Filed: Mar. 8, 2005

(30) Foreign Application Priority Data
Mar. 8, 2004 (KR) 10-2004-0015604

(51) Int. Cl. G06F 15/16

(52) U.S. Cl. 709/227

(57) ABSTRACT

A method of and a device for communication between a client and server using a flexible address. The method of receiving a flexible address includes: transmitting a request for communication with a server to a proxy, which retains the flexible address of the server; and receiving a response, which includes the flexible address from the server which received the communication request relayed by the proxy. This enables the client to independently communicate with a server which has a flexible private IP address.

### CROSS-REFERENCE TO RELATED APPLICATION

This application claims the priority of Korean Patent Application No. 2004-15604, filed on Mar. 8, 2004, in the Korean Intellectual Property Office, the disclosure of which is incorporated herein in by reference.

### BACKGROUND OF THE INVENTION

1. Field of the Invention

The present invention relates to a method of and a device for communication between a client and server.

2. Description of Related Art

Currently, with the spread of Internet usage worldwide, the lack of sufficient Internet Protocol (IP) addresses has become a serious issue. To solve this problem, a network address translator (NAT) has been introduced. A NAT is a device that converts private IP addresses of terminals linked to private networks installed within companies or homes, into public IP address which terminals linked through public networks such as the Internet can recognize, or converts public IP addresses into private IP addresses. With the introduction of NATs, not only are public IP addresses of the Internet not wasted, but since private IP addresses used within a private network cannot be known to external private networks, private networks can be protected from outside attacks.

A private IP address is provided actively by a dynamic host configuration protocol (DHCP) server. The DHCP server lends a private IP address to a terminal only when the terminal uses a provided private IP address. When usage of the private IP address ends, the DHCP server retrieves the private IP address from the terminal to actively allocate the limited private IP addresses to more terminals by shortening the lending time.

However, such a private IP address cannot be known to external private networks, and since the private IP address is flexible, a client in an external network cannot know the private IP address of a server and therefore cannot communicate with the server independently.

### BRIEF SUMMARY

An aspect of the present invention provides a method and device enabling a client to independently communicate with a server, which has a flexible private IP address.

According to an aspect of the present invention, there is provided a method of receiving a flexible address, including: transmitting a request for communication with a server to a proxy, which retains the flexible address of the server; and receiving a response, which includes the flexible address from the server which received the communication request relayed by the proxy.

According to another aspect of the present invention, there is provided a method of providing a flexible address, including: receiving a request for communication with a server relayed by a proxy, which retains the flexible address of the server; and transmitting a response to the communication received request, the response including the flexible address.

According to another aspect of the present invention, there is provided a method of relaying a communication request, including: updating a flexible address of a server; receiving a request for communication with the server from a client; and transmitting the received communication request to the server using the updated flexible address as a destination address.

According to another aspect of the present invention, there is provided a communication method including: transmitting a communication request; receiving the communication request and retransmitting the communication request using a flexible address as a destination address; and receiving the received and retransmitted communication request transmitted in the receiving the communication request and transmitting a response to the received communication request which includes the flexible address.

According to other aspects of the present invention, there are provided computer-readable storage media encoded with processing instructions for causing a processor to perform the methods of the various aspects of the present invention.

### BRIEF DESCRIPTION OF THE DRAWINGS

Additional and/or other aspects and advantages of the present invention will be set forth in part in the description which follows and, in part, will be obvious from the description, or may be learned by practice of the invention:

FIG. 1 illustrates a structure of a communication system according to an embodiment of the present invention;

FIG. 2 illustrates a structure of the server, the proxy, and the client illustrated in FIG. 1;

FIG. 3 illustrates a format of a message used in the server, the proxy, and the client illustrated in FIG. 2;

FIG. 4 illustrates a flexible address-mapping table used in the proxy illustrated in FIG. 2;

FIG. 5 is a flowchart illustrating a method of communication according to an embodiment of the present invention;

FIG. 6 is a flowchart illustrating a method of providing a flexible address according to an embodiment of the present invention;

FIG. 7 is a flowchart illustrating a method of relaying a communication request according to an embodiment of the present invention; and

FIG. 8 is a flowchart illustrating a method of receiving a flexible address according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

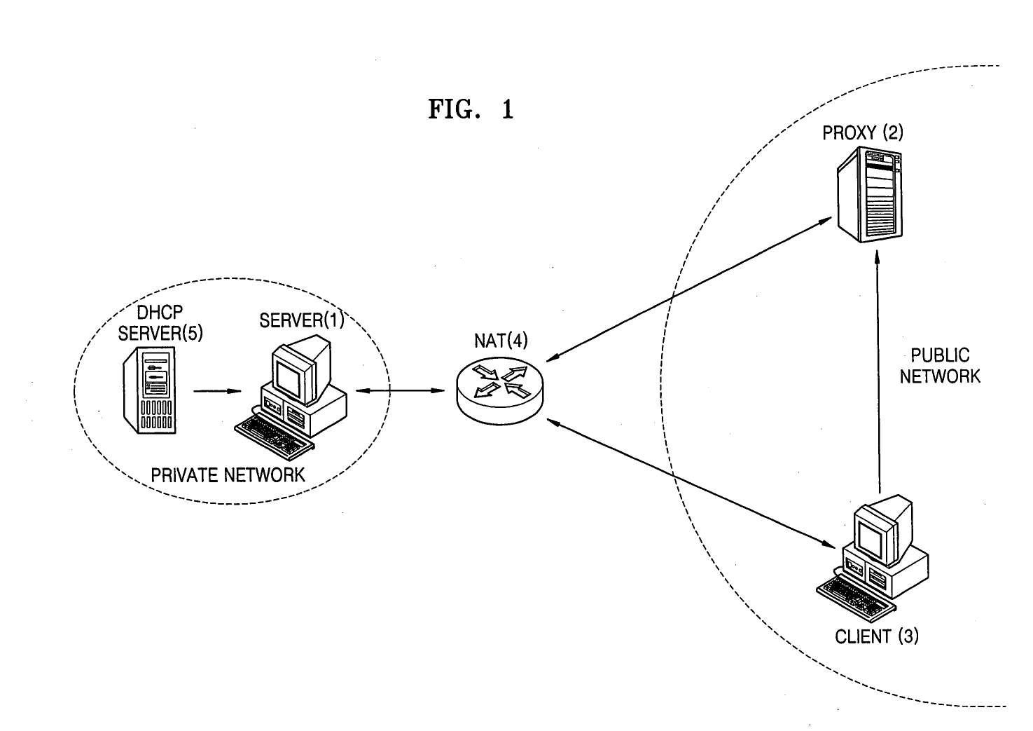

FIG. 1 is a diagram of a structure illustrating a communication system according to an embodiment of the present invention.

Referring to FIG. 1, the communication system includes a server 1, a proxy 2, a client 3, a network address translator (NAT) 4, and a dynamic host configuration protocol (DHCP) server 5.

The server 1 registers a client ID and a server ID at the proxy 2 via the NAT 4. The client ID and server ID can be registered by the client 3, but the client and server related to the application which the terminal designer is going to operate on may be designated beforehand. The server 1 registers the client ID and server ID that are coupled in the above manner.

In addition, the server 1 registers a received private IP address at the proxy 2 via the NAT 4 every time the server 1 receives the private IP address from the DHCP server 5. The address, which is registered at the proxy 2, is a public IP address that is converted from a private IP address by the NAT 4. The DHCP server 5 lends the private IP address to the server 1 only while the server 1 uses the private IP address, and when the server 1 tries to use a private IP address again, the DHCP server 5 lends another private IP address. In other words, a private IP address is a flexible address, and a public IP address, which is converted from the private IP address, is also a flexible address. The server 1 registers a converted public IP address from the changed private IP address whenever it changes its own private IP address, so that the proxy 2 can find the server 1 within a private network and communicate with it.

In addition, the server 1 transmits a packet to, or receives a packet from, the proxy 2 via the NAT 4, to maintain a connection between the server 1 and the proxy 2. The NAT 4 has a NAT table, which maps a private IP address and a public IP address one-to-one, and when a private IP address is not used for a certain amount of time, the private IP address is deleted from the NAT table. However, it is possible to map one public IP address onto many private IP addresses by allocating different transmission control protocol/user datagram protocols (TCP/UDP) to the public IP address. Therefore, the server 1 has to exchange packets with the proxy 2 to maintain a connection with the proxy 2, that is, to prevent deletion of the relevant mapping. These packets may be empty packets.

Furthermore, the server 1 receives a request for communication with the server 1 from the proxy 2 via the NAT 4 and transmits a response, which includes a private IP address, to the client 3 that transmitted the communication request, via the NAT 4. At this time, a response passes through the NAT 4, includes public IP addresses instead of private IP addresses. The server 1 communicates with the client 3, which uses a public IP address included in the received response.

The proxy 2 stores the client ID and server ID which are registered by the server 1 and client 3 so that they correspond to each other, and stores the public IP address received from the server 1 via the NAT 4 so that it corresponds to the stored server ID. Eventually, if the client ID is specific, a server ID corresponding to the client ID can be specified and a public IP address corresponding to the server ID can be specified.

In addition, the proxy 2 transmits a packet to, or receives a packet from, the server 1 via the NAT 4, in order to maintain a connection between the server 1 and the proxy 2.

In addition, the proxy 2 can receive a request for communication with the sever 1 transmitted from the client 3, and transmit the received communication request via the NAT 4 by using the public IP address as a destination address. Since the client ID is included in the received communication request, the public IP address of the server 1 can be specified from among various public IP addresses.

The client 3 registers the client ID and the server ID at the proxy 2 and transmits a request for communication with the server 1, which is related to the server ID registered at the proxy 2. The client transmits the communication request, which includes the client ID that corresponds to the server ID.

Furthermore, the client 3 receives a response, which includes a public IP address of the server 1 from the server 1 via the NAT 4, and communicates with the server 1 by finding it within the private network using the public IP address, which is included in the received response. According to the present embodiment the client 3 can find a server which has a flexible private IP address and communicate with it.

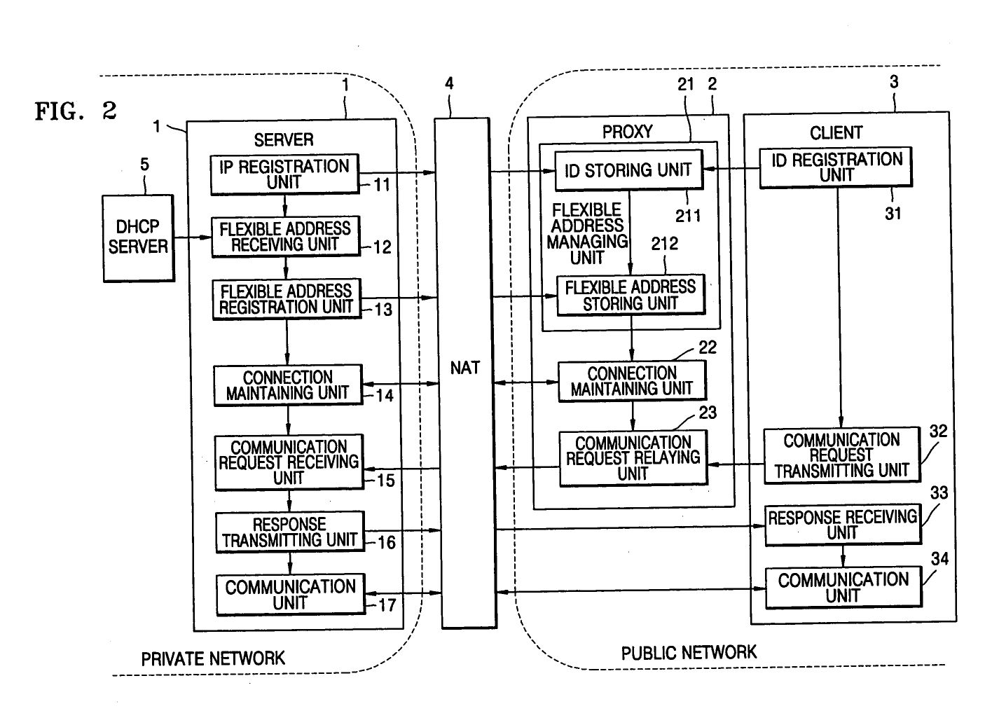

FIG. 2 is a diagram illustrating a structure of the server, the proxy, and the client shown in FIG. 1.

Referring to FIG. 2, the server 1 includes an ID register unit 11, a flexible address receiving unit 12, a flexible address registration unit 13, a connection maintaining unit 14, a communication request receiving unit 15, a response transmitting unit 16, and a communication unit 17.

The ID registration unit 11 transmits a message in which a message ID indicating that the message is for registering an ID, a client ID, and a server ID are recorded, to the proxy 2 via the NAT 4, and registers the client ID and server ID at the proxy 2. The message is recorded in the payload of an IP packet. The private IP address of the server 1 is recorded in a source address field of the IP packet output from the server 1, and the IP address of the proxy 2, that is a public IP address used in a public network (hereinafter referred as an IP address) is recorded in a destination address field of the same IP packet. If the private IP address recorded in the source address field is converted into a public IP address when going through the NAT 4, the IP packet is recorded.

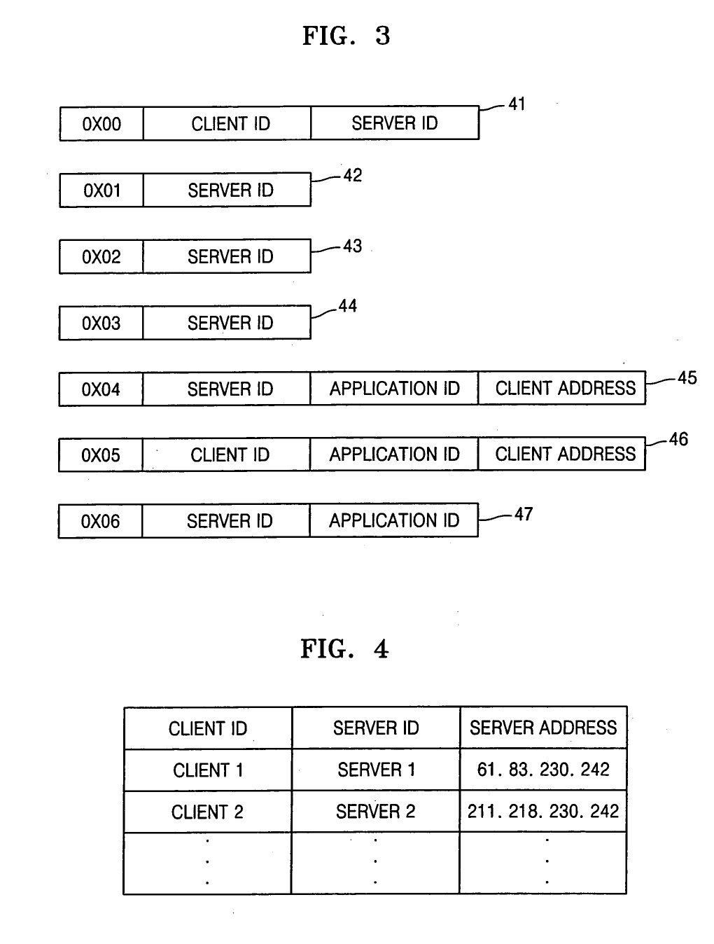

FIG. 3 is a diagram illustrating the format of a message used in the server, the proxy, and the client shown in FIG. 2.

Referring to FIGS. 2 and 3, a message 41 transmitted from the ID registration unit 11 includes a message ID field, a client ID field, and a server ID field. A message ID 0x00, which indicates that the message is for registering an ID, is recorded in the message ID field, the ID of the client 3 to be communicated with is recorded in the client ID field, and the ID of the server 1 is recorded in the server ID field.

The flexible address-receiving unit 12 receives a private IP address, which can be used within a private network, from the DHCP server 5. The flexible address registration unit 13 transmits a message ID indicating that the message is for registering a flexible address whenever a new private IP address is received, and a message in which the server ID is recorded, and registers at the proxy 2 a public IP address which is converted from the private IP address received at the flexible address receiving unit 12. The private IP address of the server is recorded in the source address field of a header of the IP packet output from the server 1 and the IP address of the proxy 2 is recorded in the destination address field. The private IP address recorded in the source address field is converted into the public IP address and recorded when the IP packet goes through the NAT 4. The public IP address, which is recorded in the destination address field of the header of the IP packet output from the NAT 4, gets registered at the proxy 2.

A message 42 transmitted from the flexible address registration unit 13 includes a message ID field and a server ID field. 0x01, which is a message ID indicating that the message is for registering a flexible address, is recorded in the message ID field, and the ID of the server 1 is recorded in the server ID field.

The connection maintaining unit 14 transmits a message in which a message ID indicating that the message is for maintaining the connection with the proxy 2, and a server ID, are recorded, to the proxy 2, which retains the public IP address registered by the flexible address registration unit 13, via the NAT 4. Or, the connection maintaining unit 14 maintains a connection with the proxy 2 by receiving a message in which a message ID indicating that the message is for maintaining the connection with the server 1, and a server ID, are recorded, from the proxy 2 via the NAT 4. In other words, meaningless packets are exchanged with the proxy 2 to prevent deletion of the mapping for the current private IP address from the NAT table loaded in the NAT 4.

A message 43 transmitted from the connection maintaining unit 14 includes a message ID field and a server ID field. 0x02, which is a message ID indicating that the message is for maintaining a connection with the proxy, is recorded in the message ID field, and the ID of the server 1 is recorded in the server ID field. This message is recorded in a payload of the IP packet.

The communication request receiving unit 15 receives a request for communication with the server 1 via the NAT 4, which is relayed through the proxy 2 while a connection is maintained by the connection maintaining unit 14, by receiving a message on which a message ID indicating that the message is a communication request message relayed through the proxy 2, a client ID, a application ID, and a client address, are recorded. An IP address of the proxy 2 is recorded in the source address field of a header of the IP packet output by the NAT 4 and the IP address of the server 1 is recorded in the source address field. The public IP address recorded in the destination address field is converted into a private IP address and recorded when the IP packet goes through the NAT 4. The server 1 which obtains the private IP address recorded in the destination address field of the header of the IP packet output by the NAT 4, as its own address, receives the IP packet. The application ID is used to discriminate between applications that a user or a terminal designer etc. has to operate on. For example, for a file transfer protocol (FTP) application the application ID can be 0x00, and for a remote data protocol (RDP) application, the application ID can be 0x01. If the application ID recorded in the message is 0x00, the FTP application receives a message recorded in a payload of the IP packet and performs an operation which the client 3 requests.

A message 46 received by the communication request receiving unit 15 includes a message ID field, a client ID field, an application ID field, and a client address field. The message ID, 0x05, indicating that the message is a communication request message relayed by the proxy 2, is recorded in the message ID field. The ID of the client 3 which is requesting communication with the server 1 is recorded in the client ID field, the application ID is recorded in the application ID field, and the IP address of the client 3 which is requesting communication with the server is recorded in the client address field.

The response transmitting unit 16 transmits a message in which a message ID indicates that preparation for communication using the specified application is complete, and a server ID and an application ID are recorded. And the response transmitting unit 16 transmits a response to the communication request received at the communication request receiving unit 15 including a flexible private IP address of the server 1, to the server via the NAT 4. The message is recorded in a payload of the IP packet. The private IP address of the server 1 is recorded in a source address field of a header of the IP packet output from the server 1, and the IP address of the client 3 is recorded in the destination address field. When the IP packet goes through the NAT 4, the private IP address recorded in the source address field is converted into a public IP address and the IP packet is recorded. The public IP address recorded in the source address field of the header of the IP packet output from the NAT 4 is transmitted to the client 3.

A message 47 received by the response transmitting unit 16 includes a message ID field, a server ID field, and an application ID field. 0x06, indicating that preparation for communication using the specified application is complete is recorded in the message ID field, the ID of the server 1 which has a flexible private IP address is recorded in the server ID field, and the application ID is recorded in the application ID field.

The communication unit 17 directly communicates with the client 3, which uses a public IP address included in the response transmitted from the response transmitting unit 16. In other words, the communication unit 17 transmits IP packets to the client 3 by using the IP address of the client 3 as the destination address that is included in the communication request received at the communication request receiving unit 15, and receives IP packets from the client 3 which uses the public IP address of the server 1 included in the response transmitted from the response transmitting unit 16 as the destination address, via the NAT 4.

The proxy 2 includes a flexible address managing unit 21, a connection maintaining unit 22, and a communication request relaying unit 23.

The flexible address managing unit 21 manages a flexible address of the server 1 by updating the flexible address of the server 1 whenever it changes. As described above, the flexible address of the server 1 is a public IP address converted from a flexible private IP address by the NAT 4. The flexible address managing unit 21 includes an ID storing unit 211 and a flexible address storing unit 212.

The ID storing unit 211 receives a message 41 of FIG. 3 whose message ID is 0x00 from the client 3 or the server 1 and stores the client ID and server ID recorded in the received message 41 so that correspond to each other. The flexible storing unit 212 receives a message 42 of FIG. 3 whose message ID is 0x01from the server 1 and stores the public ID address of the server 1 recorded in the received message 42 so that it corresponds with the server ID stored at the ID storing unit 211. In the present embodiment, a flexible address mapping table is used to store the client ID, the server ID, and the public IP address so that they correspond to each other.

FIG. 4 is a diagram illustrating a flexible address mapping table which uses the proxy shown in FIG. 2.

Referring to FIGS. 2 and 4, the flexible address mapping table includes client ID entries, server ID entries, and server address entries. A client ID is recorded in each client ID entry, a server ID associated with a client ID is recorded in each server ID entry, and a public IP address of a server which has a recorded server ID is recorded in each server address entry. Entries that correspond with each other are recorded on the same line. Therefore, when one among the three entries is specified, the remaining two automatically become specified as well. For example, if the client ID is specified as client 1, the ID of the server communicating with the client that has a client ID 1 is server 1, and the public IP address of the server is 61.83.230.242.

The connection maintaining unit 22 transmits a message whose message ID indicates that the message is for maintaining the connection with the server, to the server via the NAT 4, while the current public IP address of the server 1 and a server ID are stored by the flexible address managing unit 21. Or, the connection maintaining unit 22 maintains a connection with the proxy by receiving a message 43 of FIG. 3 whose message ID is 0x02, from the server 1 via the NAT 4. In other words, meaningless packets are exchanged with the server 1 to prevent deletion of the mapping of the current private IP address from the NAT table loaded on the NAT 4.

A message 44 received at the connection maintaining unit 22 includes a message ID field and a server ID field. 0x03, a message ID indicating that the message is for maintaining a connection with the server 1, is recorded in the message ID field, and the ID of the server 1 is recorded in the server ID field. This message is recorded in the payload of the IP packet.

The communication request relaying unit 23 receives a request for communicating with the server 1 from the client 3 by receiving a message in which a message ID indicating that the message is a request message for communicating with the server 1, a client ID, an application ID, and a client address, are recorded, and transmits the communication request received at the server 1 via the NAT 4 using the public IP address of the server 1 as a destination address, by transmitting a message 46 of FIG. 3 whose message ID is 0x05. The public IP address of the server 1 is detected from the flexible address mapping table illustrated in FIG. 4 and corresponds to the server ID coupled with the client ID recorded in the message received at the communication request relaying unit 23.

A message 45 received at the communication request relay unit 23 includes a message ID field, a server ID field, an application ID field, and a client address field. 0x04, which is a message ID indicating that the message is a request for communication with the server 1, is recorded in the message ID field, the ID of the server 1 which has the flexible private IP field is recorded in the server ID field, the application ID of a specified application is recorded in the application ID field, and the IP address of the client 3 which transmitted the request for communication with the server 1 is recorded in the client address field. The client ID recorded in the client address field is recorded in the message 46 whose message ID is 0x05 and transmitted to the server 1. This message is recorded in the payload of an IP packet. An address identical to the address recorded in the client address field of the message is recorded in the source address field of a header of the IP packet so that it is possible to detect the client address at an IP layer and relay the address to an application layer.

The client 3 includes an ID registration unit 31, a communication request transmitting unit 32, a response receiving unit 33, and a communication unit 34.

The ID registration unit 31 transmits the message 41, whose message ID is 0x00, to the proxy 2 and registers the message 41 so that the client ID and server ID correspond in the proxy 2.

The communication request transmitting unit 32 transmits the message 45, whose message ID is 0x04, to the proxy 2 and transmits a communication request to the proxy 2, which retains a flexible address that corresponds to the ID that is registered by the ID registration unit 31.

The response receiving unit 33 receives a message 47, whose message ID is 0x06, from the server 1 via the NAT 4 and receives a response, which includes a public IP address of the server 1, from the server 1 which receives the communication request relayed by the proxy 2.

The communication unit 34 communicates directly with the server 1 using the public IP address of the server 1 included in the response received at the response receiving unit 33. In other words, the communication unit 17 transmits IP packets to the server 1 via the NAT 4 by using the public IP address of the server 1 that is included in the response received at the response receiving unit 33. And the communication unit 17 also receives from the server 1 via the NAT 4 IP packets having the IP address of the client 3 that is included in a communication request transmitted from the communication request transmitting unit 32 recorded as a destination address.

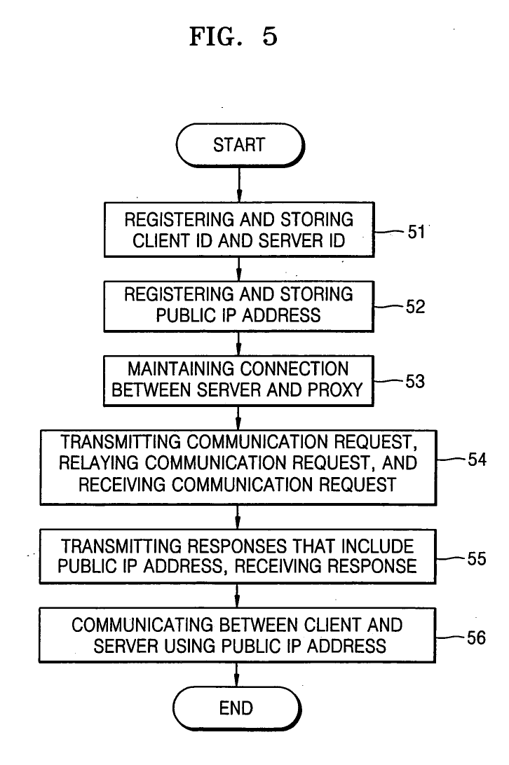

FIG. 5 is a flowchart illustrating a method of communication according to an embodiment of the present invention. The communication method may be performed in the communication system illustrated in FIG. 1 and is, for ease of explanation, described in conjunction with that system. However, it is to be understood that the subject method may be performed by other systems.

Referring to FIGS. 1 and 5, in operation 51, the server 1 or the client 3 registers the client ID and the server ID at the proxy 2 (the server 1 registers via the NAT 4). The proxy 2 stores the client ID and the server ID, which are registered by the sever 1 or the client 3, so that they correspond to each other.

Next, in operation 52, the server 1 registers the public IP address converted from the received flexible private IP address, at the proxy 2 via the NAT 4, whenever the server 1 receives a flexible private IP address from the DHCP server 5, and the proxy 2 stores the public IP address registered by the server 1 so that it corresponds to the server ID which corresponds to the client ID.

Next, in operation 53, the server 1 transmits a packet to the proxy 2 via the NAT 4, or the proxy 2 transmits a packet to the server 1 via the NAT 4, in order to maintain a connection between the server 1 and the proxy 2.

Next, in operation 54, the client transmits a request for communication with the server 1, which includes the ID of the server 1 that is registered beforehand at the proxy 2 which maintains the public IP address of the server 1. The proxy 2 receives the request for communication with the server 1 transmitted from the client 3, transmits the received communication request to the server 1 via the NAT 4 using the public IP address of the server 1 as a destination address, and the server 1 receives the communication request transmitted from the proxy 2 via the NAT 4.

Next, in operation 55, the server 1 transmits the response to the received communication request, including the flexible private IP address of the server 1, to the client 3 which transmitted the communication request via the NAT 4. In the response, which goes through the NAT 4, the public IP address is included instead of the flexible private IP address. The client 3 receives the response which includes the public IP address of the server from the server 1 via the NAT 4.

Next, in operation 56, the server 1 communicates with the client 3 using the public IP address of the server 1 included in the transmitted response, and the client 3 finds the server 1 within the private network and communicates with it using the public IP address included in the received response.

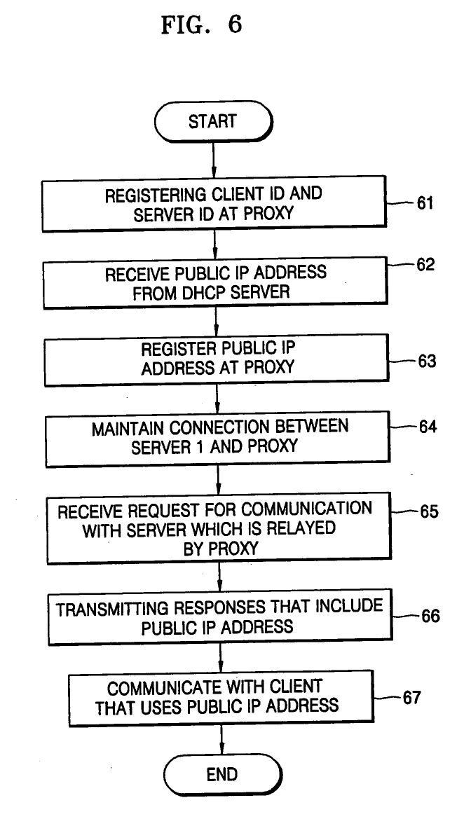

FIG. 6 is a flowchart illustrating a method of providing the flexible address according to an embodiment of the present invention. The method of providing the flexible address may be performed in the server 1 illustrated in FIG. 2 and is, for ease of explanation, described in conjunction with that server. However, it is to be understood that the subject method may be performed by other servers.

Referring to FIGS. 1 and 6, in operation 61, the client ID and the server ID are registered at the proxy 2 via the NAT 4.

Next, in operation 62, the flexible private IP address, which can be used only within a private network, is received from the DHCP server 5.

Next, in operation 63, the received flexible private IP address is registered at the proxy 2 via the NAT 4, whenever a new flexible private IP address is received. The address that is registered at the proxy 2 is the public IP address converted from the flexible private IP address by the NAT 4. The public IP address corresponds to the server ID registered in operation 61.

Next, in operation 64, a message is transmitted to the proxy 2 or received from the proxy 2 via the NAT 4 in order to maintain the connection between the server 1 and the proxy 2.

Next, in operation 65, a request for communication with the server 1, which is relayed by the proxy 2 which retains the public IP address of the server 1, is received via the NAT 4. In other words, the communication request, which has the flexible private IP address converted from the public IP address by the NAT 4 as the destination address, is received. The IP address of the client 3 which transmitted the communication request is included in the received communication request.

Next, in operation 66, a response to the received communication request, which includes the flexible private IP address of the server 1, is transmitted to the client 3 via the NAT 4. The address transmitted to the proxy 3 is the public IP address converted from the flexible private IP address by the NAT 4.

Next, in operation 67, direct communication is carried out with the client 3 which uses the public IP address included in the received response. In other words, the IP packet which uses the IP address of the client 3 included in the received communication request as the destination address is transmitted to the client 3 via the NAT 4, and the IP packet which uses the public IP address of the server 1 included in the transmitted response is received from the client 3 via the NAT 4.

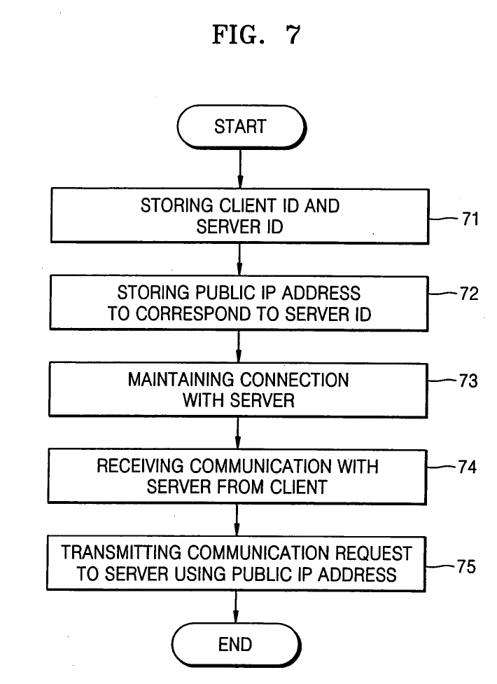

FIG. 7 is a flowchart of a method of relaying the communication request according to an embodiment of the present invention. The method of providing the flexible address may be performed in the proxy 2 illustrated in FIG. 2 and is, for ease of explanation, described in conjunction with that proxy. However, it is to be understood that the subject method may be performed by other proxies.

Referring to FIGS. 2 and 7, in operation 71, the client ID and the server ID registered by the client 3 or the server 1 are stored so that they correspond with each other.

Next, in operation 72, the public IP address, which is registered by the server 1, is stored to correspond with the server ID stored in the server 1.

Next, in operation 73, a message is transmitted to or received from the server 1 via the NAT 4 in order to maintain the connection between the server 1 and the proxy 2.

Next, in operation 74, a request for communication with the server 1 is received from the client 3.

Next, in operation 75, the communication request received at the server via the NAT 4, which uses the public IP address of the server 1 as a destination address, is transmitted. The public IP address of the server 1 corresponds to the server ID which is coupled with the client ID included in the received communication request.

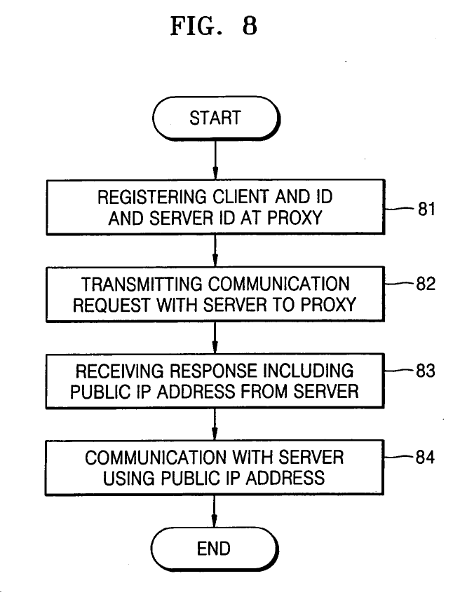

FIG. 8 is a flowchart illustrating a method of receiving the flexible address according to an embodiment of the present invention. The method of receiving the flexible address may be carried out in the client 3 illustrated in FIG. 2 and is, for ease of explanation, described in conjunction with that client. However, it is to be understood that the subject method may be performed by other clients.

Referring to FIGS. 2 and 8, in operation 81, the client ID of the client 3 and the server ID of the server 1 are registered at the proxy 2 so that they correspond to each other.

Next, in operation 82, a request for communication with the server 1 is transmitted to the proxy 2, which retains the flexible address that corresponds to the registered server ID.

Next, in operation 83, a response which includes a public IP address of the server 1 is received from the server 1 via the NAT 4.

Next, in operation 84, direct communication is carried out with the server 1 using the public IP address that is included in the received response. In other words, the IP packet which uses the public IP address of the server 1 included in the received response is transmitted to the server 1 via the NAT 4, and the IP packet which uses the IP address of the client 3 included in the transmitted communication request as a destination address is received from the server 1 via the NAT 4.

Embodiments of the present invention can be realized as a computer code stored on a computer-readable recording medium. The computer-readable recording medium includes all kinds of recording devices which store data that can be read by a computer system. ROM, RAM, CD-ROMs, magnetic tapes, hard disks, floppy disks, flash memory, and optical data storing devices are examples of the computer-readable recording medium. The computer-readable recording medium can also be carrier waves (for example, transmission through the Internet). Furthermore, the computer-readable recording medium can be accessed from a computer connected to a computer network, so that the computer code can be stored and executed remotely.

According to the above-described embodiments of the present invention, the public IP address converted from the flexible private IP address of the server in a private network is stored in the proxy, and the client can independently communicate with the server which has the flexible private IP address by transmitting a request for communication with the server to the proxy. In the current IPv4 environment, since a NAT is installed in every private network, the above-described embodiments of the present invention are useful. Moreover, as there is a high possibility that a device similar to a NAT will be used continuously to protect private networks in a future IPv6 environment, the above-described embodiments of the present invention will continue to be applicable.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of receiving a flexible address, comprising:
transmitting a request for communication with a server to a proxy, which retains the flexible address of the server; and
receiving a response, which includes the flexible address from the server which received the communication request relayed by the proxy.

2. The method of claim 1, wherein the flexible address is a public Internet protocol (IP) address converted from a flexible private IP address by a network address translator (NAT).

3. The method of claim 1, further comprising communicating with the server using the flexible address included in the received response.

4. The method of claim 1, further comprising registering an ID of a client at the proxy, wherein the transmitting includes making the request to the proxy, which retains the flexible address that corresponds to the registered ID.

5. A method of providing a flexible address, comprising:
receiving a request for communication with a server relayed by a proxy, which retains the flexible address of the server; and
transmitting a response to the communication received request, the response including the flexible address.

6. The method of claim 5, wherein the address is a public Internet protocol (IP) address converted from a flexible IP private address by a network address translator (NAT).

7. The method of claim 6, wherein the receiving includes receiving the communication request, which has the flexible private IP address that is converted from the public IP address as a destination address, via the NAT, and
wherein the transmitting includes transmitting the response, which includes the public IP address converted from the flexible private IP address, via the NAT.

8. The method of claim 5, further comprising communicating with a client which uses the flexible address included in the transmitted response.

9. The method of claim 5, further comprising registering the flexible address at the proxy, which is converted from the received flexible private address whenever the flexible private address is received from a dynamic host configuration protocol (DHCP) server.

10. The method of claim 9, further comprising registering an ID of the server at the proxy, and
wherein registering the flexible address at the proxy includes registering the flexible address which corresponds to the registered ID of the server.

11. A method of relaying a communication request, the method comprising:
updating a flexible address of a server;
receiving a request for communication with the server from a client; and
transmitting the received communication request to the server using the updated flexible address as a destination address.

12. The method of claim 11, wherein the flexible address is a public IP address, which is converted from a flexible private IP address by a NAT.

13. The method of claim 12, wherein the transmitting includes transmitting via the NAT to a server, which has the flexible private IP address converted from the public IP address.

14. The method of claim 11, further comprising transmitting a message to the server for maintaining a connection with the server, and
wherein the receiving includes receiving the communication request while maintaining a connection by transmitting a message.

15. The method of claim 11, wherein the receiving a request includes receiving a communication request which includes an ID of the client from the client and the transmitting the received communication request includes transmitting the received communication request to the server using the flexible address, which corresponds to the ID of the client that is included in the received communication request, as a destination address.

16. A communication method comprising:
transmitting a communication request;
receiving the communication request and transmitting it using a flexible address as a destination address; and
receiving the received and transmitted communication request transmitted in the receiving the communication request and transmitting a response to the received communication request which includes the flexible address.

17. The method of claim 16, wherein the flexible address is a public IP address, which is converted from the flexible IP private address by a NAT.

18. A computer-readable storage medium on which a program for performing a method of receiving a flexible address is recorded, the method comprising:
transmitting a request for communication with a server to a proxy which retains a flexible address of the server; and
receiving a response, which includes the flexible address, from the server which receives the communication request relayed by the proxy.

19. A computer-readable storage medium on which a program for performing a method of receiving a flexible address is recorded, the method comprising:
receiving a request for communication with a server relayed by a proxy which retains the flexible address of the server; and
transmitting a response to the received communication request which includes the flexible address.

20. A computer-readable storage medium on which a program for performing a method of relaying a communication request is recorded, the method comprising:
updating a flexible address of a server;
receiving a request for communication with the server from a client; and
transmitting the received communication request to the server using an updated flexible address as a destination address.

21. A computer-readable storage medium encoded with processing instructions for causing a processor to perform a communication method, the communication method comprising:
transmitting a communication request;
receiving the communication request and retransmitting the communication request using a flexible address as a destination address; and
receiving the received and retransmitted communication request transmitted in the receiving the communication request and transmitting a response to the received communication request which includes the flexible address.
